(19) United States
(12) Patent Application Publication
(10) Pub. No.: US 2022/0056371 A1
(43) Pub. Date: Feb. 24, 2022

(54) 3-IN ONE FABRIC CONDITIONERS AND SOFTENERS COMPRISING ANTIMICROBIAL AGENTS

(71) Applicant: AP Goldshield LLC, Locust Valley, NY (US)

(72) Inventor: Thomas L. Higgins, Locust Valley, NY (US)

(21) Appl. No.: 17/404,994

(22) Filed: Aug. 17, 2021

Related U.S. Application Data
(60) Provisional application No. 63/067,186, filed on Aug. 18, 2020.

(51) Int. Cl. C11D 3/00; C11D 11/00; C11D 3/48; C11D 3/37; C11D 3/30; C11D 1/835

(52) U.S. Cl. CPC C11D 3/0015; C11D 11/0017; C11D 3/48; C11D 1/72; C11D 3/30; C11D 1/835; C11D 3/3742

(57) ABSTRACT

Fabric treatment compositions are described that provide three functions to the textiles to which they are applied: sanitizing (killing microbes therein or thereon), conditioning or softening, and providing a residual antimicrobial effect to prevent immediate reinfection after treatment. Such trifunctional, or three-in-one, fabric treatments employing organosilane compounds, nonionic and cationic surfactants, a botanical (Thymol) and cationic fabric conditioners, and their use as microbicidal and microbiostatic agents, and fabric conditioners and softeners are also described.

### TECHNICAL FIELD

The invention relates to fabric treatment compositions providing three functions to the textiles to which they are applied: sanitizing (killing microbes therein or thereon, Including viruses), conditioning or softening, and providing a residual antimicrobial effect to prevent immediate reinfection. It also relates to such trifunctional, or three-in-one, fabric treatments employing organosilane compounds, a botanical, Thymol, nonionic and cationic surfactants, and cationic fabric conditioners, and their use as microbicidal and microbiostatic agents, and fabric conditioners and softeners. It also relates to such fabric treatments demonstrating sanitizing efficacy in a laundry-rinse cycle environment, while providing an antimicrobial bio-barrier after drying or curing the textile to which the fabric treatment has been applied.

### BACKGROUND OF THE INVENTION

### There is a Longfelt and Unmet Need for the Invention

There is a clear distinction between commercial healthcare and hospitality laundering protocols and consumer laundering procedures. Both the amount of solids in chemical formulations, and temperature settings used during commercial laundering, along with procedures mandated by State and/or US Federal guidelines for the healthcare commercial processes provide distinct differences from the procedures and chemical compounds and temperatures used in residential settings. The majority of consumers had believed that when they used detergents they were not only cleaning their clothes and laundry items, such as sheets, but also sanitizing them (killing microbes that may be attached). That understanding is misguided and simply wrong.

In recent events of the pandemic caused by COVID-19, and published data in the New England Journal of Medicine and The Lancet: 1. N. van Doremalen, et. al., Aerosol and Surface Stability of SARS-CoV-2 as Compared with SARS-CoV-1, N ENGL J MED, 382;16 NEJM.ORG Apr. 16, 2020; and 2. Chin et. al., Stability of SARS-CoV-2 in different environmental conditions; The Lancet Microbe 2020; published online April 2: DOI: https://doi.org/10.1016/S2666-5247(20)30003-3 (both of which are incorporated by reference in this application); show that the Coronavirus can survive on cloth for 2 days, Stainless Steel for 2-3 days and on surgical masks for 7 days. This information was quite alarming and has caused Governments to assess their use of Personal Protective Equipment (PPE), and the need for additional bio-barrier protection. This information has also heightened the awareness among consumers of their need to launder their personal clothing to ensure these materials are safe and pathogen-free, and not being the potential of vector of this disease.

In the last decade, consumers have become more educated about harmful organisms that can attach to their laundry items, microbes such as the hospital- and/or community-acquired methicillin-resistant strains of Staphylococcus aureus (MRSA). The announcement by the Centers for Disease Control and Prevention (CDC) that MRSA kills more people in the USA today than AIDS, and the publicity surrounding that proclamation, has created alarm and awareness about the transmission of this disease. It has also created a demand for a product that would sanitize and protect clothes from the re-introduction of many of these harmful microbes by creating a bio-barrier with residual (lasting) performance.

Take, for example, athletes. Rick Lannetti was once the picture of health, a big strong college football player at Lycoming College in Williamsport, Pa. In the fall of 2003, he led his team to a big victory, securing a spot in the national semi-finals. However, after the game he caught something attributed to his uniform and one week after his final game he was dead. His death was attributed to MRSA. Bill Pennington, THE NEVER ENDING BATTLE AGAINST SPORT'S HIDDEN FOE, NY Times, Oct. 6, 2017.

Locker rooms, gyms, and related athletic facilities, and textiles such as shared towels and uniforms, offer potential sites for MRSA contamination and infection. A study linked MRSA to the abrasions caused by artificial turf, a synthetic textile. The Texas State Department of Health has found the infection rate among football players was 16 times the national average Sophia Kazakova, CA-MRSA in Athletics, Texas Department of State Health Services, meeting on CAM RSA Infections, Austin Tex. Sep. 9, 2004. In October 2006, a high-school football player was temporarily paralyzed from MRSA-infected turf burns. His infection returned in January 2007 and required three surgeries to remove infected tissue, as well as three weeks of hospital stay.

In 2013, Lawrence Tynes, Carl Nicks, and Johnthan Banks of the Tampa Bay Buccaneers were diagnosed with MRSA. Rick Stroud, Tampa Bay Times, Aug. 22, 2013. Tynes and Nicks apparently did not contract the infection from each other, but it is unknown if Banks contracted it from either individual. In 2015, Los Angeles Dodgers infielder, Justin Turner, was infected while the team visited the New York Mets. In October 2015, New York Giants tight end Daniel Fells was hospitalized with a serious MRSA infection. Some of these have now been identified as being derived from textiles.

When the CDC announced estimates that 70% of university athletic departments are contaminated with MRSA it raised consumer concerns. As a consequence, consumers now are seeking protection, as 20-30 million Americans visit health clubs several times a week, and they undergo the risk of having their athletic clothing becoming a vector of disease. To obviate that risk will require home sanitizing and after-market bio-barrier protection.

Hospitals, on the other hand, are keenly aware of the problems associated with harmful organisms that attach to textiles that must be removed in a sanitizing process, which generally will call for a percentage of bleach, cationic and nonionic surfactants, and high heat temperature settings to help sanitize these textiles, a process not available to the average consumer using home laundering machines.

In an article by Shefali Luthra, Health News from NPR, JAMA Internal Medicine (Mar. 15, 2016), it was reported that almost 1 in 4 adults who left the hospital had on their hands a super-bug—a virus, bacterium, or other kind of microbe that resists multiple kinds of medicines. It is evident that hands become a vector of disease and as such can easily transfer these organisms to the clothing their owners wear. That will require sanitizing and most preferably protection on their clothes to resist these microbes in the first instance.

Equally troubling is that, once textiles are laundered, whether using hospital-grade or consumer products, there is no residual protection against harmful organisms when either a detergent or sanitizing agent is used. This problem has generated a demand for antimicrobial formulations such as described in U.S. Pat. No. 9,089,138 to Higgins and Shlisky (hereinafter “Higgins-Shlisky” and which is herein incorporated by reference as if fully set forth in its entirety), which will provide a prophylactic bio-barrier protection against the re-introduction of harmful organisms.

Additionally, with the advent of synthetic fibers and blends thereof, in such materials as microfiber (synthetic) sheets, athletic apparel products, synthetic undergarments, and inert materials used in the healthcare sector, fabric conditioners or softeners are in greater demand, as many detergents and the heat these fabrics are exposed to tend to stiffen fabrics, making them brittle and coarse.

Therefore, in the world of consumer laundering there is a need to: a) not alter the procedures in home washing, i.e., using a detergent, rinsing, and adding a softener; and to b) create a product formulation that would be all-inclusive of the following three functions: (i) sanitizing [disinfecting], (ii) softening, and (iii) shielding or protecting the textiles against the re-introduction of harmful organisms with an antimicrobial bio-barrier after curing or drying them.

The same needs exist in many commercial laundry settings to help minimize labor and processing time, while: (i) sanitizing [disinfecting], (ii) softening, and (iii) shielding or protecting the textiles against the re-introduction of harmful organisms with an antimicrobial bio-barrier after curing or drying them.

### BACKGROUND OF THE RELATED ART

Organosilanes containing quaternary ammonium halides and hydrolysable alkoxy groups bonded to silicon have been employed in a wide variety of applications. The hydrolyzable groups enable these compounds to form bonds to substrates that contain hydroxyl, alkoxy, oxide, and similar reactive moieties. Organosilanes have been used for fabric treatment and for surface modification of substrates that enhance miscibility in organic solvents or enable subsequent operations to be conducted on the substrate such as dyeing or painting.

Organosilane quaternary nitrogen compounds have been employed effectively in eliminating and reducing bacterial, viral, and fungal contamination when applied to a variety of surfaces including metal, glass, plastics, rubber, ceramics, and fabrics, including cellulose, cotton, acetates, polyester, nylon, and blends of synthetic fibers and cotton.

Water-stable organosilane compounds, products, and compositions for treating various substrates, articles treated with the compounds, products and compositions, and methods of treatment using the compounds, products, and compositions are disclosed in U.S. Pat. Nos. 5,959,014, 6,221,944 and 6,632,805 to Liebeskind and Allred (each of which is herein incorporated by reference as if fully set forth in its entirety). Textile antimicrobial treatments attributed to DOW Corning 5700 or Piedmont Chemicals Ztrex® have employed 3-trimethoxysilylpropyldimethloctadecyl ammonium chlorides. See, for example, U.S. Pat. No. 3,794,736 to Abbott et al. (hereinafter “Abbott” and which is herein incorporated by reference as if fully set forth in its entirety).

Solvent based organosilane compounds are described in Abbott, which describes the method of inhibiting the growth of bacteria and fungi using organosilicon amines.

Other water-stable organosilane compounds integrated with nonionic surfactants at specific ratios for treating various substrates and textiles are disclosed in U.S. Pat. No. 9,089,138 to Higgins and Shlisky (hereinafter “Higgins-Shlisky”) and which is incorporated by reference herein, as if fully set forth in its entirety. The Higgins-Shlisky formulations most preferably are selected from the organosilane quaternary ammonium chlorides, and nonionic surfactants described in Higgins-Shlisky.

Other organosilanes quaternary ammonium compounds may be used as described in Higgins-Shlisky. Suitable organosilanes may be selected from groups consisting of 3-(trihydroxysilyl) propyloctadecyldimethyl ammonium chloride, 3-(trimethoxysilyl) propyloctadecyldimethyl ammonium chloride, trisanol derivatives, polysiloxanol derivatives, and mixtures thereof.

While the art of disinfection has advanced significantly in recent years, there remain challenges and unmet needs in improving antimicrobial agents with virucidal efficacy and applying them in residential community, hospital, and commercial settings.

### SUMMARY OF THE INVENTION

Fabric treatment compositions are described that provide three functions to the textiles to which they are applied: a) sanitizing (killing microbes therein or thereon), b) conditioning or softening, and c) providing a residual antimicrobial effect to prevent immediate reinfection. Such trifunctional, or three-in-one, fabric treatments employing organosilane compounds, nonionic and cationic surfactants, a botanical, Thymol, and cationic fabric conditioners, and their use as microbicidal and microbiostatic agents, and fabric conditioners and softeners are also described.

In some embodiments, a three-in-one fabric treatment composition includes an organosilane compound, a nonionic surfactant, a cationic surfactant, a botanical, Thymol effective against COVID 19 and other viral pathogens and a cationic fabric conditioner. In some embodiments an article treated by the fabric treatment composition is simultaneously sanitized, conditioned, and provided with a residual bio-barrier, the residual viral bio-barrier effective to inhibit infection of the treated textile by microorganisms for a period of time.

In some embodiments a method of making a three-in-one fabric treatment composition is described. In some embodiments the method includes mixing together an organosilane compound, a nonionic surfactant, a cationic surfactant, a botanical Thymol and a cationic fabric conditioner.

This, being a summary, is necessarily brief and does not put forth all of the features and advantages of the novel fabric treatment compositions, methods of making them, or methods of using them in applications. The invention may be more fully understood with reference to the drawing and the detailed description that follow.

### BRIEF DESCRIPTION OF THE DRAWINGS

FIG. 1 is a schematic diagram of mechanism by which the inventive product may attach to a fabric to provide a residual bio-barrier to recurrent infection of the fabric by a microbe.

FIG. 2 is a schematic diagram of a mechanism by which a microbe may be killed by a fabric treated with the inventive product.

### DETAILED DESCRIPTION OF THE INVENTION

The invention relates to compositions employing organosilane compounds, nonionic and cationic surfactants, a botanical, Thymol and cationic fabric conditioners, and their use as microbicidal and micro-biostatic agents, and fabric conditioners and softeners demonstrating sanitizing efficacy in a laundry-rinse cycle, while providing a bio-barrier protection after drying or curing, all within one formulation.

In a prior unpublished study at Pace University of the Higgins-Shlisky formulation entitled: Evaluation of Goldshield Antimicrobial Treated Masks of Polypropylene Against Methicillin Resistant Strain of, Staphylococcus aureus, a copy of which is attached as Appendix 1 and is incorporated by reference herein, when applied by spraying or wet padding on fabrics, albeit not by laundry additives, there was strong evidence of biocidal efficacy against certain bacterium, i.e., methicillin resistant Staphylococcus aureus. Also, see an unpublished study by MICROCHEM Laboratory in 2016, showing biocidal efficacy against Influenza A (H1N10) and Human Coronavirus and Poliovirus, on treated medical masks, a copy of which is attached as Appendix 2 and is incorporated by reference herein.

In a recent published study, the Higgins-Shlisky formulation was shown to provide >99.3% efficiency against three bacterial species tested that settled on surgical mask surfaces, as reported by Chun-Chieh Tseng et al., Applications of a Quaternary Ammonium Agent on Surgical Face Masks before use of pre-decontamination of Nosocomial infection-related bioaerosols, in Aerosol Science and Technology, 50:3, 199-210, DOI:10.1080/02786826.2016.1140895(2016), which is incorporated by reference herein. Another unpublished study was recently conducted at the Wuhan Institute of Virology on medical masks that found that the Higgins-Shlisky formulation treated masks killed COVID-19 (SAR-CoV-2) 99.88% over three days, demonstrating the kill and residual activity. The reason this is important is it supports the efficacy on textiles and the residual actions since COVID can survive on surgical masks for 7 days; a copy of which is attached as Appendix 3 and is incorporated by reference herein.

The inventors discovered that the botanical, Thymol would be a more highly effective virucidal agent, which is recommended as surface disinfectant by the EPA-CDC listing for viral pathogens for use against sars-cov 2 (Covid-19), which can be found at https://www.epa.gov/pesticide-registration/list-n-disinfectants-use-against-sars-cov-2-covid-19, which is attached as Appendix 4 and is incorporated by reference herein. A concern is that Thymol is prone to self-condensation in water and not stable unless it is maintained at a neutral pH. However, even at neutral pH, Thymol would self-condense within days, making it commercially unusable in laundry formulations. The inventors, however, found that if Thymol could be stabilized in a water based system, it would provide the enhanced virucidal effects desired to kill Covid-19 and other surrogate viruses such as SARS.

In particular, the inventors discovered that they could cross link the carbon chain of the Higgins-Shlisky organosilane formulation with Thymol and stabilize the formulation in water by the employment of the most preferred polyol, pentaerythritol, disclosed in the Higgins-Shlisky patent. To stabilize the botanical along with the organosilane, the polyol has to contain at least three hydroxy groups, in which all of the hydroxy groups are separated by at least three intervening atoms, and in which the polyol is one of the compound(s): pentaerythritol, dipentaerythritol, or tripentaerythritol. Additionally, the inventors have found that the employment of these polyols, required physical reaction time of approximately seven to twelve hours for the organosilane and Thymol to be fully stabilized, thereby making it a strong laundry sanitizing and viral disinfecting formulation.

In some embodiments the formulations most preferably are selected from the organosilane quaternary ammonium chlorides and nonionic surfactants described in Higgins-Shlisky. Other organosilanes quaternary ammonium compounds may be used. Suitable organosilanes may be selected from groups consisting of 3-(trihydroxysilyl) propyloctadecyldimethyl ammonium chloride, 3-(trimethoxysilyl) propyloctadecyldimethyl ammonium chloride, trisanol derivatives, polysiloxanol derivatives, and mixtures thereof.

In some embodiments the formulation encapsulate a botanical within the organosilane quaternary ammonium chloride and this botanical, Thymol, with disinfecting virucidal features, by cross linking the carbon compounds of the organosilane with the carbon chain of the thymol.

In one embodiment, cross-linking the alkyl chains of cationic surfactants of organic salts or quaternary ammonium compound, preferably alkylbenzyldimethylammonium chlorides of the linear formula C₆H₅CH₂N(CH₃)₂RCI (where R=C₈H₁₇ to C₁₈H₃₇), creates and enhances a stronger biocidal (sanitizing) action against a broad spectrum of organisms, such as bacteria, and some fungi, yeasts, and viruses, when used in a water or rinse cycle environment and/or when applied to substrates in ambient temperatures by spraying, wiping, fogging, or rolling.

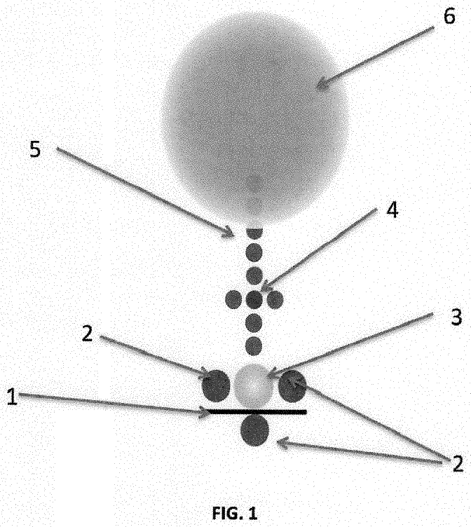

FIG. 1 is a schematic diagram of mechanism by which the inventive product attaches to a fabric to provide a residual bio-barrier to recurrent infection of the fabric by a microbe. The surfactant 2 penetrates the fabric surface 1, reducing the surface energy (surface tension) between the water bearing the inventive formulation and the fabric surface 1. This permits the silane carrier 3 to bond with the fabric surface 1. The silane carrier 3 attaches to the fabric surface 1 by covalent bonding, forming a monomolecular layer. The positively charged nitrogen group 4 of the inventive composition positively charges the substrate (fabric surface 1), attracting the microorganism (microbe) 6 to the fabric surface 1. The long carbon chain 5 attached to the positively charged nitrogen group 4 disrupts the cell wall and membrane of the microorganism 6, killing it.

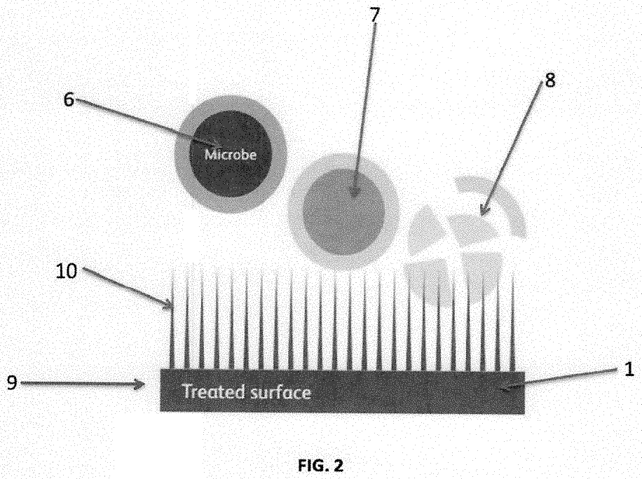

FIG. 2 is a schematic diagram of a mechanism by which a microbe 6 may be killed by a fabric treated with the inventive product. In FIG. 2, the treated fabric 9 is represented by a flat fabric surface 1 onto which are affixed a plurality of spikes 10, each representing the inventive composition comprising the silane carrier 3, the positively charged nitrogen group 4, and the long carbon chain 5, as depicted in FIG. 1. The diagram depicts the progress of a microbe 6 approaching the treated fabric surface 9 as time progresses from left to right. The microbe 6 arrives in the vicinity of the treated fabric surface 9, and encounters at least one spike 10. At this point, its cell wall and membrane are disrupted as seen in the center, and it becomes a disrupted microbe 7. Further exposure to the inventive composition comprising the silane carrier 3, the positively charged nitrogen group 4, and the long carbon chain 5 causes more damage, resulting in the killed microbe 8. Additionally, by cross linking the botanical, thymol, with the long carbon chain of the Higgins-Shlisky organosilane, it provides a significant and unique improvement of and for viral protections.

In another embodiment, it has been found that regardless of application technique, advantageous formulations employing these organosilanes compounds can be made with the employment of a nonionic wetting agent of organosilane compounds and compositions as previously described in Higgins-Shlisky. These formulations can be applied via the spraying technique or added to fabrics in a variety of application processes. Most preferably the formulation is used as an additive in home or commercial laundry machines during the machine's rinse cycle, or in the commercial application to textiles by exhausting on during the rinse procedures, or yet again by wet padding these formulations to fabric substrates and yet another application of a low micron spray dispensing technique as described in Higgins-Shlisky. The formulation provides an advantage by allowing for more coverage of the substrate to be treated, and longer-lasting fabric protection against the re-introduction of microbial organisms after the substrate or textile has been cured or dried. These features and benefits when added to textiles occur after the curing or drying stage, however they are not sufficiently effective in a water or rinse cycle environment such as encountered during laundering in laundry equipment.

In another embodiment, a cationic surfactant, preferably of the alkylbenzydimetylammonium chloride composition, has the advantage of increasing and enhancing the killing functionality of the formula in a water or rinse cycle environment. At percentages ranging from 1.5% to 2.5%, it adds a broad-spectrum sanitizing effect on bacteria, certain fungi, yeasts, and viruses. It is effective in a water processing environment, such as when added to a rinse cycle, meaning it is sanitizing the textiles or clothes in the laundry machine and does not have to be cured or dried to be effective. (See Table 1.)

In another embodiment the softener composition preferably comprises at least one organic chosen from the group consisting of fatty acid liquids, aminoethylethanolamine (an amide of stearic acid), dimethyl sulfate, fatty acid triglyceride transester, tallow amine ethoxylate, diethyl sulfate, glycerol esters, ethoxylated fatty esters, fatty alcohols, polyol polymers, cationic organic compounds, and synthetic esters and natural esters and mixtures thereof. Most preferably, citric acid will be added to adjust the pH, because when cotton is acidified it develops a negative charge called the negative Zeta potential. Adding citric acid adjusts the pH and resulting in an ionic attraction for the positively charged fabric softener.

A nonionic wetting agent is advantageously employed to provide the characteristics of a facilitator to reduce surface tension and allow the composition to more rapidly penetrate the textile and substrate to be treated, as described in Higgins-Shlisky. Reducing the interfacial tension between the two media (the antimicrobial agent with the nonionic) will permit the formula to penetrate the textile and surface more quickly while providing greater coverage on the surface. In Higgins-Shlisky this phenomenon was illustrated in FIG. 2A and FIG. 2B. FIG. 2A illustrated a droplet of a formulation comprising a nonionic wetting agent while FIG. 2B illustrated a droplet without the wetting agent. See also Table 17.

Suitable nonionic wetting agents include ethoxylated alcohols; ethoxylated nonyl phenol(s); and ethoxylated alkyl phenol(s). When choosing a nonionic surfactant it is most preferred that the ethoxylation is between 9-12 moles to give the best wetting and detergency. Lower or higher ethoxylation reduces the surface tension properties and thus is not preferred, although it could provide some improved characteristics.

Preferably, the nonionic wetting agent is selected from the group consisting of ethoxylated nonyl phenol 9-12 moles, ethoxylate, ethoxylated alcohol 9-12 moles and ethoxylate, and ethoxylated alkyl phenols 9-12 moles ethoxylate. Most preferably, the nonionic wetting agent is ethoxylated nonyl phenol 9-12 moles.

Employing the nonionic surfactants in the compositions of the present invention, whether water-stable or solvent-based, provides an advantage over previously described compositions in that they will better adhere to textiles and surfaces, including inert materials such as polypropylene, polyvinyl acetates, and polystyrene. In addition, improved flow into crevices in surfaces is made possible. Another advantage is that the disclosed compositions can allow for the formation of smaller droplets when using an aerosolization application method. This application technique allows for the smaller droplet size to increase their affinity to certain surfaces and textiles, including materials composed of inert fibers. The surface tension of the droplets is reduced and thus allows the compositions to covalently bond more quickly and will sanitize with the addition of the alkylbenzydimetylammonium chloride. The compositions are non-toxic and so they can be applied to surfaces, textiles, and substrates in such exemplary industries as the healthcare, consumer home use, and food and beverage industries without fear of harming subjects, advantageously human subjects who come into contact with treated surfaces or textiles, or who eat or handle food products.

The botanical, Thymol, was the botanical employed because the compounds can cross link to the organosilane and it will remain active as a strong viral disinfectant complimenting the organosilane, particularly where viruses such as COVID 19 survive on textiles longer than most other substrates. They achieved the stabilization of thymol in the formulation by the use of polyols that had to contain at least three hydroxy groups, wherein all of the hydroxy groups are separated by at least three intervening atoms, in which the polyol is one or more of the compound(s): pentaerythritol, dipentaerythritol, or tripentaerythritol.

The cationic surfactant is employed to enhance the biocidal killing functionality and sanitizing impacts of these compositions on textiles and surfaces. It can sanitize fabrics and clothes in a water based environment, such as home and commercial rinse cycles of laundry machines. (See Table 1.) The action is due to the disruption of the intermolecular interactions within the microorganism which disrupts the cell wall and membrane of the microorganism and results in its death. This can cause dissociation of cellular membrane lipid bilayers of infective organisms, which disrupts cellular permeability controls, and induces leakage of cellular contents resulting in death of the infective organisms. It also increases the speed of the biocidal function against these organisms: whereas bleach can take 3 to 10 minutes to kill microbes, microorganisms are killed sometime between immediate contact and 3 minutes after contact when exposed to the formulas of the present invention.

The most preferable cationic surfactant employed in the composition is of the mixture of alkylbenzyldimethylammonium chloride, C₆H₅CH₂N(CH₃)₂RCI (where R=C₈H₁₇ to C₁₈H₃₇), to enhance the biocidal killing functionality in a water environment or rinse cycle in washing machines, whereas the organosilane-nonionic surfactant is more efficacious after curing or drying.

The most preferable botanical employed in the composition is Thymol C₁₀H₁₄O, which is cross linked to the carbon chain of the organosilane and stabilized in water by the polyol used in the Higgins-Shlisky patent, as Thymol is generally unstable and prone to self-condensation when the pH is not neutral. To stabilize the botanical along with the organosilane the polyol has to contain at least three hydroxy groups, wherein all of the hydroxy groups are separated by at least three intervening atoms, wherein the polyol is of the compound: pentaerythritol, dipentaerythritol, or tripentaerythritol,

The fabric softener composition preferably comprises at least one organic chosen from the group consisting of fatty acid liquids, aminoethylethanolamine, dimethyl sulfate, fatty acid triglyceride transester, tallow amine ethoxylate, diethyl sulfate, glycerol esters, ethoxylated fatty esters, fatty alcohols, polyol polymers, cationic organic compounds, and synthetic esters and natural esters and mixtures thereof. Most preferably citric acid will be added to adjust the pH, because when cotton is acidified it will develop a negative charge called the negative Zeta potential. By adding citric acid it will adjust the pH and this will result in an ionic attraction for the positively charged fabric softener.

Advantages of the invention include: sanitizing (killing organisms, such as viruses and bacterium) on fabrics in a water or rinse cycle environment as well as in air (when sprayed on substrates); softening fabrics; and creating a bio-barrier with residual protection after curing.

Additional advantages when cleaning/laundering personal protective equipment (“PPE”), such as masks, gowns, and gloves, permits these PPE to be reused and protected. In critical or emergency environments. It is common for front line staff not to change PPE between patients as oftentimes there is not time to remove and replace them. The features and benefits to disinfect and protect add significant value to both the wearer and the patient.

These three features and benefits of the invention provide for a one-step application to fabrics used in a home or commercial laundry machine during the injection of the compounds in a rinse cycle or by spraying on fabrics to sanitize and protect against the re-introduction of microorganisms. In home or commercial laundry machines, use of the compounds of the present invention do not disrupt the normal injection of fabric softeners regularly used after the detergent phase of laundering. It sanitizes while in the water-rinse environment, it softens during the same in-water process, and it protects after curing or drying through the employment of the organosilane-nonionic composition most preferably as detailed in Higgins-Shlisky.

When dispensed in a spray, the organosilane-nonionic forms a covalent bond to textiles, while the cationic compound sanitizes them, and fabric conditioner provides softness to the materials. When deployed on hard surfaces, the same reaction of sanitizing and protecting occurs, while employing a de minimus, or lesser, amount of the conditioner. By having a one-step operation the invention facilitates consumer and commercial applications. Advantageously, the invention does not require an extra add-on process, which is economical in both the savings of labor and use of chemistries. When sprayed on PPE the organosilane and the botanical form a bio-barrier by crosslinking to inert materials. As referenced in the MICHROCHEMLAB Mask study vs. coronavirus that is referenced in paragraph 28 and attached as Appendix 2, this study demonstrated that the Higgins-Shlisky organosilane composition prevent 94% of coronavirus in ten minutes. In yet another publication Chun-Chieh Tseng et al., Applications of a Quaternary Ammonium Agent on Surgical Face Masks before use of pre-decontamination of Nosocomial infection-related bioaerosols, in Aerosol Science and Technology, 50:3, 199-210, DOI:10.1080/02786826.2016.1140895(2016) concluded: “Our study demonstrates that a quaternary ammonium compound, GSS, can be coated onto the filter of surgical layers and provide a durable antimicrobial effect when bacterial aerosols settle down or penetrate the mask.”

By incorporating Thymol, into the composition, the disinfectant properties increase.

In various embodiments, surfaces, textiles and substrates treatable with the compositions, products, and compositions of the invention solution include, but are not limited to, textiles, carpet, carpet backing, curtains, curtain bathroom liners, drapes, throw rugs, towels, underclothes, socks, upholstery, sports and daily clothing, sponges, plastics, metals, surgical dressings, masonry, silica, sand, alumina, aluminum chlorohydrate, titanium dioxide, calcium carbonate, wood, glass beads, containers, tiles, floors, curtains, marine products, tents, backpacks, roofing, siding, fencing, trim, insulation, wall-board, trash receptacles, outdoor gear, compressible and incompressible fluid filtration materials, water purification systems, and soil. Furthermore, articles treatable with the compounds, products, and compositions of the invention include, but are not limited to, materials used for the manufacture thereof, aquarium filters, buffer pads, fiberfill for upholstery, fiberglass duckboard, underwear and outerwear apparel, polypropylene fabrics, filters and membranes, polyurethane and polyethylene foam, metals, sand bags, tarpaulins, sails, ropes, shoes, socks, towels, disposal wipes, hosiery and intimate apparel, cosmetics, lotions, creams, ointments, disinfectant sanitizers, absorbents, wound dressings; micro-fibers, wood preservatives, plastics, adhesives, paints, pulp, paper, cooling water, and laundry additives and non-food- or food-contacting surfaces in general.

The composition can be added in liquid form, as a pod with liquid release, or as a solid as a laundry additive during the rinse cycle, wet padded on at the manufacturing of textiles, or exhausted during the rinse cycle in continuous-flow processes in the production of textiles. It can be sprayed, rolled, wiped, fogged, or applied by mopping the article or surface to be treated. It can also be processed through dipping, soaking, or roller pressure and heat setting processing. Choice of the application and/or processing method depends upon the nature of the surface or textile to be treated.

As previously stated, the composition can be advantageously used in aerosolization spray techniques for certain surfaces or rooms with the spray comprising preferably small micron-size droplets such as 1 to 8 microns, most preferably 0.5 to 5 microns, as detailed in Higgins-Shlisky. This benefits the application process by minimizing labor and providing consistency and balance in the application process, while sanitizing and protecting against the re-introduction of organisms. The aerosolization spray technique can be done with minimal labor force.

Another advantageous application method is applying by “wet-wipes.” First by soaking the wipe with the composition, letting it remain moist in a container, and then applying it to substrates. This is an effective application providing the surface with the desired prophylactic-residual protection, because by lowering the interfacial tension between the two media of the antimicrobial and the wetting agent, the resulting composition will play a key role in the removal of dirt and organisms from surfaces and textiles and it will sanitize or disinfect surfaces or textiles with the addition of the preferred cationic surfactant.

### EXAMPLE 1

### Preparation 1 of Organosilane-Nonionic-Cationic-Conditioner Water-stabilized Composition

### Formula A

Flowing from a 72% concentrate of 3-(trimethoxysilyl)propyldimethyloctadecyl ammonium chloride a 5% w/v (weight/volume) aqueous solution of 3-(trimethoxysilyl) propyldimethyloctadecyl ammonium chloride was converted to 5% 3-(trihydroxysilyl) propyldimethyloctadecyl ammonium chloride, 0.8% 3-chloropropyltrimethoxysilane, and 1.9% pentaerythritol, hereinafter “Formula A”) pursuant to the reference in Higgins-Shlisky. In brief, a 22 [symbol] reaction flask was charged with 6250 g (21.0 mol) of dimethyloctadecylamine, 5844 g (29.4 mol) of 3-chloropropyltrimethoxysilane, and 76 g (0.84 mol) of trioxane. The mixture was heated to 140° C. for 7 hours while stirring and was then cooled to 80° C. Two [symbol] of methanol was then added and the mixture was cooled to approximately 40° C.

This mixture was then transferred to 171 [symbol] of water, into which 4000 g of pentaerythritol (approximately about 29.38 mol) had been previously dissolved. After thorough mixing the pH of the formula was checked. If the pH is above 7.0 (basic) a small amount of HCl is added until the pH is below 7.0, preferably pH 4.75 to 5.50.

The mixture was then diluted to 209 [symbol] with additional deionized water (Formula A). To a quantity of Formula A (to equate to 90% of the final mixture), was added 10% of the nonionic Tergitol NP-10 (ethoxylated nonyl phenol 10 moles ethylene oxide (EO)). The amount of 2.4% of alkylbenzydimetylammonium liquid was then added by taking 3% of a premixed 80% alkylbenzydimetylammonium liquid concentrate, and 0.5% Thymol was added in an amount to form the complete Formula A.

### Formula B

The mixture of Formula A, with the nonionic surfactant, was further diluted by taking 10 parts and blending it to an 87% pre-mixed fabric conditioner preferably of the composition containing 11.05% solids and 86% water of the formula made of 1% citric acid, 8% AEEA (aminoethylethanolamine), which converts to a cationic using DMS (dimethyl sulfate). This is then blended with 2% of tallow triglyceride transester. An amount (approximately 0.8%) of tallow amine ethoxylate is reacted with 0.2% of diethyl sulfate. An amount of 1% of a cationic amine is added to complete the fabric conditioner mixture. The resulting amide quat (quaternary) becomes the main softening agent, the ester helps to further stabilize the silane quat and the tallow amine ethoxylate will help reduce static electricity. When cotton is acidified it will develop a negative charge called the negative Zeta potential. By adding 0.8% to 1.2% of citric acid it will adjust the pH from 2.5 to 3.25 and this will result in an ionic attraction for the positively charge fabric softener.

The preferable composition will result in 77 parts softener, 20 parts the Formula A of the organosilane-nonionic, 0.5% botanical [Thymol] and 3 parts the cationic surfactant of alkylbenzyldimethylammonium chloride.

The preferable resulting compositions are: a) 0.7% to 1.5% of the organosilane C₂₃H₅₂CINO₃Si; b) 0.12% to 2.8% of the cationic surfactant/biocide C₆H₅CH₂N(CH₃)₂RCI (where R=C₈H₁₇ to C₁₈H₃₇); c) 0.15% to 4.0% of the nonionic surfactant: most preferably Tergitol NP-10 (ethoxylated nonyl phenol 10 moles EO) DOW Corning; d) 0.25-0.15% Thymol C10H14O; e) 8 to 12 parts solids of the softener composition: containing 11.05% solids and 86% water of the formula made of 1% citric acid, 8% AEEA (aminoethylethanolamine), which converts to a cationic using DMS (dimethyl sulfate). This is then blended with 2% of tallow triglyceride transester. An amount (approximately 0.8%) of tallow amine ethoxylate is reacted with 0.2% of diethyl sulfate. An amount of 1% of a cationic amine is added to complete the fabric conditioner mixture The resulting amide quat (quaternary) becomes the main softening agent, the ester helps to further stabilize the silane quat and the tallow amine ethoxylate will help reduce static electricity. When cotton is acidified it will develop and negative charge called the negative Zeta potential. By adding 0.8% to 1.2% of citric acid it will adjust the pH from 2.5 to 3.25 and this will result in an ionic attraction for the positively charge fabric softener.

### Example 2

### Preparation 2 of Organosilane-Nonionic-Cationic-Conditioner Composition

### Formula C

From a 72% concentrate of 3-(trimethoxysilyl)propyldimethyloctadecyl ammonium chloride) a dilution to a 1% to 2% w/v (weight to volume) concentrate of 3-(trimethoxysilyl)propyldimethyloctadecyl ammonium chloride, and 0.1% to 0.3% 3-chloropropyltrimethoxysilane is added to a pre-mixture of 10% ethoxylated propoxylated alcohols and 10% propylene glycol to stabilize the 3-(trimethoxysilyl)propyldimethyloctadecyl ammonium chloride in the fabric conditioner mixture. To a quantity of Formula C (to equate to 90% of the final mixture), was added 10% of the nonionic Tergitol NP-10 (ethoxylated nonyl phenol 10 moles ethylene oxide (EO)). The amount of 2.4% of alkylbenzydimetylammonium liquid was then added by taking 3% of a premixed 80% alkylbenzydimetylammonium liquid concentrate, and 0.5% Thymol was added in an amount to form the complete Formula C. After thorough mixing the pH of the solution was checked. If the pH is above 7.0 (basic) a small amount of HCl was added until the pH is below 7.0, preferably pH 4.75 to 5.50.

Preferable resulting compositions are: a) 0.7% to 1.5% of the organosilane C₂₃H₅₂CINO₃Si (CAS# 27668-52-6), Piedmont Chemicals Ztrex® or DOW Corning 5700; b) 0.12% to 2.8% of the cationic surfactant/biocide C₆H₅CH₂N(CH₃)₂RCI (where R=C₈H₁₇ to C₁₈H₃₇); c) 0.15% to 4.0% of the nonionic surfactant, most preferably Tergitol NP-10 (ethoxylated nonyl phenol 10 moles EO) DOW Corning; d) 0.25-0.15% Thymol C10H14O; e) 8 to 12 parts solids of the fabric softener composition: 87% pre-mixed fabric conditioner preferably of the composition containing 12% solids and 86% water of the formula made of 1% citric acid, 8% AEEA (aminoethylethanolamine), which converts to a cationic using DMS (dimethyl sulfate). This is then blended with 2% of tallow triglyceride transester. An amount (approximately 0.8%) of tallow amine ethoxylate is reacted with 0.2% of diethyl sulfate. An amount of 1% of a cationic amine is added to complete the fabric conditioner mixture The resulting amide quat (quaternary) becomes the main softening agent, the ester helps to further stabilize the silane quat and the tallow amine ethoxylate will help reduce static electricity. When cotton is acidified it will develop and negative charge called the negative Zeta potential. By adding 0.8% to 1.2% of citric acid it will adjust the pH from 2.5 to 3.25 and this will result in an ionic attraction for the positively charge fabric softener.

While the above is a description of what are presently believed to be the preferred embodiments of the invention, various alternatives, modifications, and equivalents may be used. Those skilled in the art will realize that other and farther embodiments can be made without departing from the spirit of the invention, and it is intended to include all such further modifications and changes as come within the true scope of the following claims. Therefore, the above description should not be taken as limiting the scope of the invention, which is defined solely by the claims.

We claim:

1. A three-in-one fabric treatment composition comprising:
an organosilane compound;
a nonionic surfactant;
a cationic surfactant;
a botanical, Thymol and
a cationic fabric conditioner; and
wherein an article treated by the fabric treatment composition is simultaneously sanitized, conditioned, and provided with a residual bio-barrier, the residual bio-barrier effective to inhibit an infection of the treated textile by microorganisms for a period of time.

2. The three-in-one fabric treatment composition of claim 1, wherein:
the period of time during which the infection of the treated article is inhibited is at least 24 hours.

3. The three-in-one fabric treatment composition of claim 1, wherein:
the organosilane compound comprises an organosilane quaternary ammonium chloride and a botanical, Thymol.

4. The three-in-one fabric treatment composition of claim 1, wherein:
the organosilane compound is selected from the group composed of 3-(trihydroxysilyl) propyloctadecyldimethyl ammonium chloride, 3-(trimethoxysilyl) propyloctadecyldimethyl ammonium chloride, trisanol derivatives, polysiloxanol derivatives, and mixtures thereof.

5. The three-in-one fabric treatment composition of claim 1, wherein:
the nonionic surfactant is selected from the group composed of ethoxylated alcohols, ethoxylated nonyl phenol(s), and ethoxylated alkyl phenol(s).

6. The three-in-one fabric treatment composition of claim 1, wherein:
the cationic surfactant comprises an alkylbenzyldimethylammonium chloride having the formula C₆H₅CH₂N(CH₃)₂RCI (where R=C₈H₁₇ to C₁₈H₃₇).

7. The three-in-one fabric treatment comprises a botanical, Thymol having the formula C₁₀H₁₄O, which has been stabilized in the formula of claim 1 by polyol(s) that have to contain at least three hydroxy groups, wherein all of the hydroxy groups are separated by at least three intervening atoms, wherein the polyol is of the compound(s): pentaerythritol, dipentaerythritol, or tripentaerythritol.

8. The three-in-one fabric treatment composition of claim 1, wherein:
the cationic fabric conditioner comprises at least one organic chosen from the group consisting of fatty acid liquids, aminoethylethanolamine, dimethyl sulfate, fatty acid triglyceride transester, tallow amine ethoxylate, diethyl sulfate, glycerol esters, ethoxylated fatty esters, fatty alcohols, polyol polymers, cationic organic compounds, and synthetic and natural esters and mixtures thereof.

9. The three-in-one fabric treatment composition of claim 1, comprising:
approximately 77 parts of the cationic fabric softener;
approximately 3 parts of the cationic surfactant, the cationic surfactant preferably comprising alkylbenzyldimethylammonium chloride; and
approximately 20 parts of a solution comprising the organosilane compound and the nonionic surfactant.

10. The three-in-one fabric treatment composition of claim 1, comprising: 0.7% to 1.5% of the organosilane C₂₃H₅₂CINO₃Si;
0.15% to 4.0% of the nonionic surfactant, wherein the nonionic surfactant most preferably comprises ethoxylated nonyl phenol 10 moles ethylene oxide;
0.12% to 2.8% of the cationic surfactant C₆H₅CH₂N(CH₃)₂RCI (where R=C₈H₁₇ to C₁₈H₃₇); 0.25%-0.5% botanical, Thymol (C₁₀H₁₄O) and 8 to 10 parts solids of the cationic fabric conditioner, wherein the cationic fabric conditioner preferably comprises 87% pre-mixed fabric conditioner preferably of the composition containing 10% solids of the formula made of aminoethylethanolamine.

11. The three-in-one fabric treatment composition of claim 9, further comprising:
tallow triglyceride transester; and
tallow amine ethoxylate reacted with diethyl sulfate.

12. The three-in-one fabric treatment composition of claim 10, further comprising:
0.8% to 1.2% of citric acid.

13. A method of making a three-in-one fabric treatment composition, the method comprising:
charging a reaction flask with 21.0 Mol of dimethyloctadecylamine, 29.4 Mol of 3-chloropropyltrimethoxysilane, and 0.84 Mol of trioxane to form a first mixture;
heating the first mixture to approximately 140° C. for approximately 7 to 12 hours while stirring;
cooling the first mixture to approximately 80° C.;
adding 2 [symbol] of methanol to form a second mixture;
cooling the second mixture to approximately 40° C.;
preparing a first solution by dissolving 4000 g of pentaerythritol in 171 [symbol] of water;
adding the cooled second mixture to the first solution and thoroughly mixing the two;
adjusting the resulting second solution's pH to a value preferably between 4.75 and 5.50 by adding a sufficient amount of HCl;
adding an amount of alkylbenzydimetylammonium liquid with a concentration of 2.4% to the pH-adjusted second solution to form a third solution; adding an amount of a botanical, Thymol in a concentration of 0.5%,
diluting the third solution with additional deionized water to a volume of 209 [symbol] to form Formula A;
adding ethoxylated nonyl phenol and 8-10 Moles ethylene oxide to Formula A in an amount to produce the three-in-one fabric treatment composition comprising 90% Formula A and 10% ethoxylated nonyl phenol 10 moles ethylene oxide.

14. The method of claim 13, the method further comprising:
blending 10 parts of the three-in-one fabric treatment composition comprising 90% Formula A and 10% ethoxylated nonyl phenol 10 moles ethylene oxide with an 87% pre-mixed fabric conditioner preferably of the composition containing 10% solids of the formula made of aminoethylethanolamine to form a first blend;
adding to the first blend a small percentage of tallow triglyceride transester to form a second blend;
reacting a small amount of tallow amine ethoxylate with diethyl sulfate to form an amide quaternary;
adding the amide quaternary to the second blend; and
adding 0.8% to 1.2% of citric acid such that the pH of the resulting blend is approximately 2.5.

15. A method of making a three-in-one fabric treatment composition, the method comprising:
charging a reaction flask with 21.0 mol of dimethyloctadecylamine, 29.4 mol of 3-chloropropyltrimethoxysilane, and 0.84 mol of trioxane to form a first mixture;
heating the first mixture to approximately 140° C. for 7 hours while stirring;
cooling the first mixture to 80° C.;
adding 2 [symbol] of methanol to the first mixture to form a second mixture;
cooling the second mixture to approximately 40° C.;
adding 4000 g of a premixed solution in propylene glycol with a decyl alcohol ethoxylate capped with propylene oxide, along with a lauryl alcohol EO and PO capped to 171 [symbol] of water to form a third mixture;
blending the second and third mixtures in an approximate ratio of 80:20 and mixing thoroughly to form a first solution;
adjusting the resulting first solution's pH to a value preferably between 4.75 and 5.50 by adding a sufficient amount of HCl;
adding an amount of alkylbenzydimetylammonium liquid with a concentration of 2.4% to the pH-adjusted second solution to form a second solution;
diluting the second solution with additional deionized water to a volume of 209 [symbol] to form Formula C;
adding ethoxylated nonyl phenol 10 moles ethylene oxide to Formula C in an amount to produce the three-in-one fabric treatment composition comprising 90% Formula C and 10% ethoxylated nonyl phenol 10 moles ethylene oxide.

16. A three-in-one fabric treatment composition made by the method of claim 13.

17. A three-in-one fabric treatment composition made by the method of claim 15.
